(19) United States
(12) Patent Application Publication
(10) Pub. No.: US 2019/0054906 A1
(43) Pub. Date: Feb. 21, 2019

(54) AIRCRAFT BRAKING SYSTEM AND METHOD USING RUNWAY CONDITION PARAMETERS

(71) Applicant: Rockwell Collins, Inc., Cedar Rapids, IA (US)

(72) Inventors: Rakesh Pedapudi, Lingampally (IN); Vijay Rajanna, Banglore (IN)

(73) Assignee: Rockwell Collins, Inc., Cedar Rapids, IA (US)

(21) Appl. No.: 16/042,652

(22) Filed: Jul. 23, 2018

(30) Foreign Application Priority Data
Aug. 18, 2017 (IN) 201711029307

(51) Int. Cl. B60T 8/17; B64D 45/04; B64C 25/42; G08G 5/00

(52) U.S. Cl. CPC B60T 8/1703; G08G 5/0091; B64C 25/42; B64D 45/04

(57) ABSTRACT

A system includes a sensor, a transmitter, and an aircraft having a processing circuit and a transceiver. The sensor is configured to measure contamination on a runway surface and to output contamination information relating to the measured contamination. The transmitter is configured to receive the contamination information and to wirelessly communicate the received contamination information. The transceiver is configured for wireless communication with the transmitter. The processing circuit is configured to receive the contamination information, determine a plurality of landing parameters based on the contamination information, and control at least one of a wheel brake or a reverse thruster in response to determining the plurality of landing parameters.

### CROSS-REFERENCE TO RELATED PATENT APPLICATIONS

The present application claims the benefit of and priority to Indian Application Serial No. 201711029307, filed on Aug. 18, 2017, entitled “AIRCRAFT BRAKING SYSTEM AND METHOD USING RUNWAY CONDITION PARAMETERS” by Pedapudi, which is incorporated herein by reference in its entirety.

### BACKGROUND

The inventive concepts disclosed herein relate generally to the field of aircraft braking systems. More particularly, embodiments of the inventive concepts disclosed herein relate to aircraft braking systems based on measured runway surface conditions including contamination and environmental conditions.

Contamination and environmental conditions can often affect aircraft landing operations. A view of the runway through a cockpit of the aircraft may be obstructed or otherwise have low visibility due to weather conditions, making it difficult for an operator of the aircraft to determine landing and braking procedures. While the operator can receive indications of runway conditions from generic air traffic reports, these indications may be limited to general contamination forecasts relating to water, snow, etc. Accordingly, these aircraft braking systems do not dynamically adapt or have pre-selected braking modes based on runway conditions. Moreover, these systems do not provide warnings or an estimated touchdown point based on current runway conditions.

### SUMMARY

In one aspect, the inventive concepts disclosed herein are directed to a system. The system includes a sensor, a transmitter, and an aircraft. The sensor is configured to measure contamination on a runway surface and to output contamination information relating to the measured contamination. The transmitter is configured to receive the contamination information and to wirelessly communicate the received contamination information. The aircraft includes a processing circuit and a transceiver. The transceiver is configured for wireless communication with the transmitter. The processing circuit is configured to receive the contamination information. The processing circuit is further configured to determine landing parameters based on the contamination information. The processing circuit is further configured to control at least one of a wheel brake, a reverse thruster, or an air brake and spoiler system in response to determining the landing parameters.

In a further aspect, the inventive concepts disclosed herein are directed to a system for use with a sensor configured to measure contamination on a runway surface and to output contamination information relating to the measured contamination, and a transmitter configured to receive the contamination information and to wirelessly communicate the received contamination information. The system includes a processing circuit and a transceiver. The transceiver is configured for wireless communication with the transmitter. The processing circuit is configured to receive the contamination information, determine landing parameters based on the contamination information, and control at least one of a wheel brake or a reverse thruster of an aircraft in response to determining the landing parameters.

In a further aspect, the inventive concepts disclosed herein are directed to a method. The method includes measuring, by a sensor, contamination on a runway surface. The method further includes communicating, by a transmitter, contamination information to an aircraft, the contamination information relating to the measured contamination. The method further includes determining, by a processing circuit of the aircraft, landing parameters based on the contamination information. The method further includes controlling, by the processing circuit, at least one of a wheel brake or a reverse thruster in response to determining the landing parameters.

In a further aspect, the inventive concepts disclosed herein are directed to a brake control unit of an aircraft. The brake control unit includes a transceiver configured for wireless communication and a processing circuit communicably coupled to the transceiver. The processing circuit is configured to receive contamination information relating to measured contamination of a runway surface. The processing circuit is further configured to determine landing parameters based on the contamination information. The processing circuit is further configured to control at least one of a wheel brake or a reverse thruster in response to determining the landing parameters.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A is a schematic illustration of an exemplary embodiment of an aircraft control center according to the inventive concepts disclosed herein;

FIG. 1B is a schematic illustration of an exemplary embodiment of an aircraft according to the inventive concepts described herein;

FIG. 2 is a block diagram of an exemplary embodiment of a system configured to operate based on accurate runway conditions mapping according to the inventive concepts disclosed herein;

FIG. 3 is a block diagram of an exemplary embodiment illustrating an aircraft braking system according to the inventive concepts disclosed herein;

FIG. 4 is a diagram of an exemplary embodiment of a method of configuring an aircraft braking system based on accurate runway conditions mapping according to the inventive concepts disclosed herein; and

FIG. 5 is a diagram of an exemplary embodiment of a method of determining landing parameters of an aircraft braking system according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features which may not necessarily be expressly described or inherently present in the instant disclosure.

Broadly, embodiments of the inventive concepts disclosed herein are directed to systems and methods for improved runway braking, including contaminated runway surface detection for improved braking efficiency. In some embodiments, a system includes at least one sensor configured to measure contamination on a surface of a runway. The sensor can be configured to detect a type of contaminant (e.g., water, snow, ice) and a contaminant depth value (e.g., less than one-eighth inch, between one-eighth inch and one-quarter inch, etc.). The system may also include at least one sensor configured to measure environmental information corresponding to the runway. Environmental information can relate to wind speed, wind direction, temperature, etc. The system can also include a transmitter configured to wirelessly communicate information relating to measured contamination and/or measured environmental information to an aircraft for landing the aircraft. The aircraft can include a processing circuit configured to determine a friction level based on the measured contamination. The processing circuit can be configured to control operation of at least one of a wheel brake, a reverse thruster, an air brake, and a spoiler based on the indication of friction and/or environmental information. The processing circuit can also be configured to determine a minimum stopping distance and a touchdown point for safely landing the aircraft. The system can include a display device, and the processing circuit can be configured to generate a visualization for displaying on the display device based on the contamination information, the environmental information, the wheel brake operation, the reverse thruster operation, the minimum stopping distance, and/or the touchdown point.

Systems manufactured in accordance with the inventive concepts described herein can optimize landing procedures according to current runway conditions, such as contamination on a runway surface and environmental conditions. Systems described herein can improve landing safety by dynamically adapting aircraft braking systems, calculating stopping distances, and identifying touchdown points. Systems described herein can also provide visual warnings and relevant information to an operator or pilot of the aircraft.

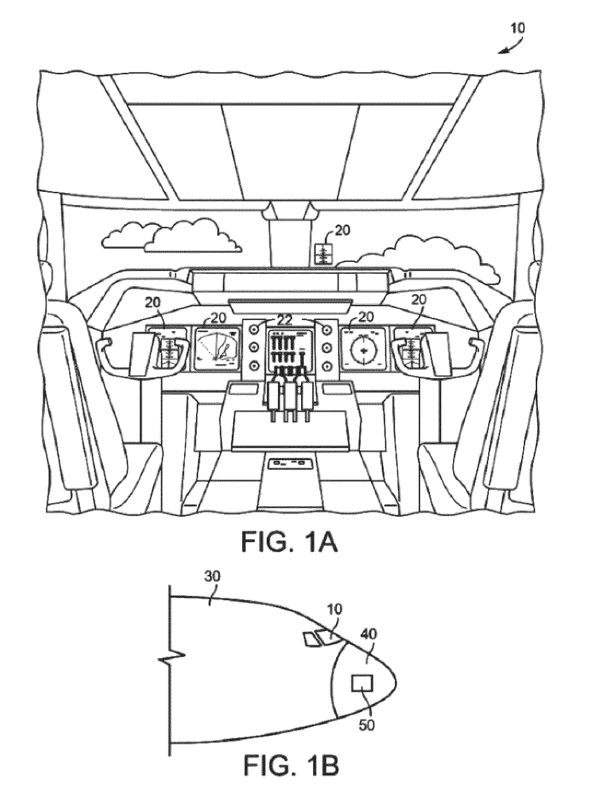

Referring to FIG. 1A, a perspective view schematic illustration of an aircraft control center 10 of an aircraft is shown accordingly to an exemplary embodiment of the inventive concepts disclosed herein. The aircraft control center 10 can be configured for an aircraft operator or other user to interact with avionics systems of the aircraft. The aircraft control center 10 may include one or more flight displays 20 and one or more user interface (“UP”) elements 22. The flight displays 20 may be implemented using any of a variety of display technologies, including CRT, LCD, LED backlight, touchscreen, organic LED, dot matrix display, and others. The flight displays 20 may be navigation (NAV) displays, primary flight displays, electronic flight bag displays, tablets such as iPad® computers manufactured by Apple, Inc. or tablet computers, synthetic vision system displays, head up displays (HUDs) with or without a projector, wearable displays, watches, Google Glass® or other head-worn display systems. The flight displays 20 may be used to provide information to the flight crew, thereby increasing visual range and enhancing decision-making abilities. One or more of the flight displays 20 may be configured to function as, for example, a primary flight display (PFD) used to display altitude, airspeed, vertical speed, and navigation and traffic collision avoidance system (TCAS) advisories. One or more of the flight displays 20 may also be configured to function as, for example, a multi-function display used to display navigation maps, weather radar, electronic charts, TCAS traffic, aircraft maintenance data and electronic checklists, manuals, and procedures. One or more of the flight displays 20 may also be configured to function as, for example, an engine indicating and crew-alerting system (EICAS) display used to display critical engine and system status data. Other types and functions of the flight displays 20 are contemplated as well. According to various exemplary embodiments of the inventive concepts disclosed herein, at least one of the flight displays 20 may be configured to provide a rendered display from the systems and methods of the inventive concepts disclosed herein.

In some embodiments, the flight displays 20 may provide an output based on data received from a system external to the aircraft, such as a ground-based weather radar system, satellite-based system, a sensor system, or from a system of another aircraft. In some embodiments, the flight displays 20 may provide an output from an onboard aircraft-based weather radar system, LIDAR system, infrared system or other system on the aircraft. For example, the flight displays 20 may include a weather display, a weather radar map, and a terrain display. In some embodiments, the flight displays 20 may provide an output based on a combination of data received from multiple external systems or from at least one external system and an onboard aircraft-based system. The flight displays 20 may include an electronic display or a synthetic vision system (SVS). For example, the flight displays 20 may include a display configured to display a two-dimensional (2-D) image, a three-dimensional (3-D) perspective image of terrain and/or weather information, or a four-dimensional (4-D) display of weather information or forecast information. Other views of terrain and/or weather information may also be provided (e.g., plan view, horizontal view, vertical view). The views may include monochrome or color graphical representations of the terrain and/or weather information. Graphical representations of weather or terrain may include an indication of altitude of the weather or terrain or the altitude relative to the aircraft. The flight displays 20 may receive image information, such as a visualization generated based on an indication of a runway surface condition, and display the image information.

The UI elements 22 may include, for example, dials, switches, buttons, touch screens, keyboards, a mouse, joysticks, cursor control devices (CCDs), menus on Multi-Functional Displays (MFDs), or other multi-function key pads certified for use with avionics systems. The UI elements 22 may be configured to, for example, allow an aircraft crew member to interact with various avionics applications and perform functions such as data entry, manipulation of navigation maps, and moving among and selecting checklist items. For example, the UI elements 22 may be used to adjust features of the flight displays 20, such as contrast, brightness, width, and length. The UI elements 22 may also (or alternatively) be used by an aircraft crew member to interface with or manipulate the displays of the flight displays 20. For example, the UI elements 22 may be used by aircraft crew members to adjust the brightness, contrast, and information displayed on the flight displays 20. The UI elements 22 may additionally be used to acknowledge or dismiss an indicator provided by the flight displays 20. The UI elements 22 may be used to correct errors on the flight displays 20. The UI elements 22 may also be used to adjust the radar antenna tilt, radar display gain, and to select vertical sweep azimuths. Other UI elements 22, such as indicator lights, displays, display elements, and audio alerting devices, may be configured to warn of potentially threatening conditions such as severe weather, terrain, and obstacles, such as potential collisions with other aircraft.

Referring now to FIG. 1B, an aircraft 30 is shown according to an exemplary embodiment of the inventive concepts disclosed herein. The aircraft 30 includes a nose 40, an aircraft transceiver 50, and the aircraft control center 10. The aircraft transceiver 50 as referred to in this disclosure can be any device capable of unidirectional (e.g., a receiver) or bidirectional communication (e.g., a transceiver). The aircraft transceiver 50 can employ one or more antennas capable of wireless communication at one or more frequencies or channels, such as HF, VHF, SATCOM, HFDL, etc. Although the aircraft transceiver 50 is shown within the nose 40, the aircraft transceiver 50 can be configured in any suitable manner within or on the aircraft 30.

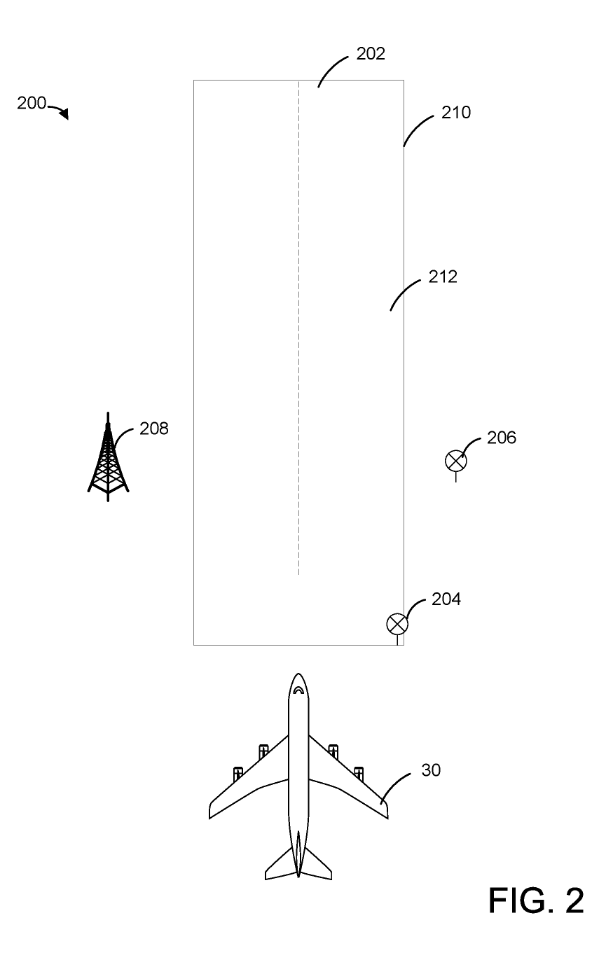

Referring now to FIG. 2, a system 200 configured to operate based on accurate runway conditions mapping is shown according to an exemplary embodiment. The system 200 is shown to include the aircraft 30, a runway 202, a plurality of contamination sensors 204, a number of environmental condition sensors 206, and a wireless transmitter 208.

The runway 202 is shown to have a runway length 210 and a runway surface 212. The runway length 210 has a value generally corresponding to a minimum stopping distance for safely landing the aircraft 30 in optimal and various suboptimal conditions. For example, landing the aircraft 30 may require more of runway length 210 when runway surface 212 is exposed to heavy contamination and/or when aircraft 30 experiences a heavy tailwind. In contrast, landing the aircraft 30 may require less of runway length 210 when the runway surface 212 is exposed to minimal contamination. The runway surface 212 can be of any conventional or suitable type for landing the aircraft 30. In some embodiments, properties of the runway surface 212 can affect a coefficient of friction between a tire of the aircraft 30 and the runway surface 212. For example, properties can include a material and texture of the runway surface 212.

Each of the plurality of contamination sensors 204 is generally configured to measure contaminants on the runway surface 212. In some embodiments, each of the contamination sensors 204 can be configured to be flush-mounted on or nearby the runway surface 212 such that the contamination sensors 204 can measure a contaminant depth value. Examples of types of contaminants include water, frost, slush, ice, wet ice, wet snow, wet snow over ice, dry snow, dry snow over ice, compacted snow, water over compacted snow, dry snow over compacted snow, slush over ice, ash, rubber, oil, sand, mud, etc. Embodiments of the system 200 can include any number of the contamination sensors 204. For example, system 200 can include a first contamination sensor 204 configured to measure water, snow, and/or ice; and system 200 can also include a second contamination sensor 204 configured to measure another contaminant, such as ash or mud. In some embodiments, the system 200 is configured with multiple contamination sensors 204 at multiple locations of runway surface 212 for measuring contamination at various locations of the runway surface 212.

In some embodiments, each of the contamination sensors 204 is configured to output contamination information to the transmitter 208. In this regard, each of the contamination sensors 204 is communicably connected to the transmitter 208. Contamination information can include both an indication of the type of contamination and of a depth value. For example, the contamination information can indicate “water film” and “one-sixteenth inch.” In some embodiments, contamination information does not include an indication of depth value. For example, when contamination sensor 204 measures a water film value less than one-sixteenth inch, the contamination information may only indicate “wet.” In contrast, when the contamination sensor 204 measures a water film value greater than one-sixteenth inch, the contamination information may indicate “water” and “one-sixteenth inch.”

Each of the plurality of environmental condition sensors 206 is generally configured to measure one or more environmental or ambient conditions. For example, the environmental condition sensors 206 can relate to a wind speed sensor, a wind direction sensor, a temperature sensor, a humidity sensor, or any other device capable of measuring an environmental condition relevant to landing the aircraft 30. In some embodiments, the environmental condition sensor 206 can be located on or nearby the runway surface 212. In some embodiments, one or more of the environmental condition sensors 206 can be configured at a farther distance from the runway 202 relative to contamination sensor 204. Embodiments of the system 200 can include any number of the environmental condition sensors 206.

In some embodiments, each of the environmental condition sensors 206 is configured to output environmental information to the transmitter 208. Environmental information can include measured environmental or ambient conditions. In some embodiments, each of the environmental condition sensors 206 is communicably connected to the transmitter 208.

The transmitter 208 is generally configured to receive contamination information from the contamination sensors 204 and environmental information from the environmental condition sensors 206. The transmitter 208 as referred to in this disclosure can be any device capable of unidirectional or bidirectional communication (e.g., transceiver). In some embodiments, the transmitter 208 is a device or system configured for air traffic control transmission. Embodiments of the system 200 can include any number and/or type of transmitter 208. For example, in some embodiments, one or more of the transmitters 208 can be provided in a ground station proximate to the runway 202 and/or be provided in a satellite. In this regard, each of the transmitters 208 can include a wired or wireless interface to receive the contamination information and/or the environmental information. In other embodiments, a single device includes both the transmitter 208 and the contamination sensor 204 or the environmental condition sensor 206. The transmitter 208 can provide the environmental condition information to the aircraft 30 through one or more intermediate transmitters or networks in some embodiments. In some embodiments, the environmental condition information is provided to a web site (e.g., an aviation administration web site) that is accessed by the aircraft 30.

In some embodiments, the transmitter 208 is configured to wirelessly communicate to the aircraft transceiver 50 of the aircraft 30 the received contamination information and/or the environmental information. The transmitter 208 can be configured to wirelessly transmit contamination information and/or the environmental information to aircraft transceiver 50 using any suitable means. For example, the transmitter 208 can employ one or more antennas capable of wireless communication at one or more frequencies or channels, such as HF, VHF, SATCOM, HFDL, etc. In some embodiments, the contamination information and/or the environmental information is provided via a notice relating to NOTAM, SNOWTAM, and/or ASHTAM. In some embodiments, the transmitter 208 is configured to wirelessly transmit contamination information and/or the environmental information to the aircraft transceiver 50 in response to an indication that the aircraft 30 is within a certain distance of runway 202, such as twenty or thirty nautical miles.

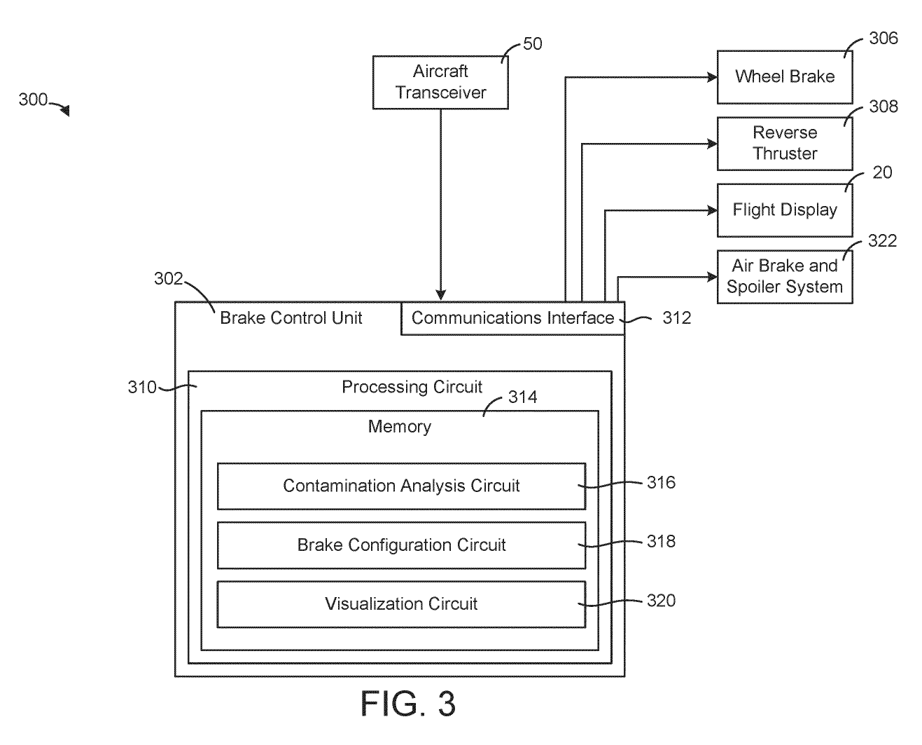

Referring now to FIG. 3, an aircraft braking system 300 is illustrated in accordance with the inventive concepts described herein. In some embodiments, the aircraft braking system 300 is provided in the aircraft 30. The aircraft braking system 300 is shown to include a brake control unit 302, the aircraft transceiver 50, at least one wheel brake 306, at least one reverse thruster 308, an air brake and spoiler system 322, and one or more of the flight displays 20.

The brake control unit 302 is generally configured to control the wheel brake 306, the reverse thruster 308, the air brake and spoiler system 322, and/or the flight display 20 based on the contamination information and/or the environmental information. In this regard, the brake control unit 302 is shown to include a communications interface 312. The communications interface 312 is generally configured to receive contamination information and/or environmental information from the transceiver 50. In some embodiments, the aircraft transceiver 50 is configured to wirelessly receive contamination information and environmental information from the transmitter 208.

The wheel brake 306 is generally configured to decrease a speed of the aircraft 30. For example, the wheel brake 306 can be coupled to, included in, or integrated with landing gear of the aircraft 30, including wheels that are used to travel along a surface (e.g., a ground surface, a landing surface or strip, a runway). The processing circuit 310 can be configured to control operation of the wheel brake 306 (e.g., transmit instructions to the wheel brake 306 that cause the wheel brake 306 to be activated or to be applied to the wheels; transmit instructions indicating a level or magnitude at which the wheel brake 306 is applied; transmit instructions to an avionics system that controls the wheel brake 306 to control operation of the wheel brake 306).

The reverse thruster 308 is also configured to decrease a speed of the aircraft 30 (e.g., a reverse-thrust mechanism that can be controlled by an operator of the aircraft 30 from throttle controllers in the cockpit, such as by redirecting exhaust gases from engines of the aircraft 30). In some embodiments, the aircraft braking system 300 can include a plurality of reverse thrusters 308 that can each be individually controlled by the brake control unit 302. The reverse thruster 308 can be integrated with existing engines of the aircraft 30, or can be separately positioned on the aircraft 30. The reverse thruster 308 can be oriented to face an opposite direction of a longitudinal axis of the aircraft 30 or a direction of travel of the aircraft 30 (e.g., opposite a direction by which engines of the aircraft 30 cause the aircraft 30 to move). The processing circuit 310 can be configured to control operation of the reverse thruster 308 (e.g., transmit instructions to the reverse thruster 308 that cause the reverse thruster 308 to be activated; transmit instructions indicating a level or magnitude at which the reverse thruster 308 is applied; transmit instructions to an avionics system that controls the reverse thruster 308 to control operation of the reverse thruster 308).

The air brake and spoiler system 322 can also be configured to decrease a speed of the aircraft 30. The air brake and spoiler system 322 can include any conventional system of air brakes and/or spoilers. In some embodiments, the air brake and spoiler system 322 is configured to affect drag and/or an angle of approach during landing of the aircraft 30. For example, the processing circuit 310 can be configured to control operation of the air brake and spoiler system 322 (e.g., transmit instructions to the air brake and spoiler system 322 that cause the air brake and spoiler system 322 to be activated; transmit instructions indicating a level or magnitude at which the air brake and spoiler system 322 is applied; transmit instructions to an avionics system that controls the air brake and spoiler system 322 to control operation of the air brake and spoiler system 322). In some embodiments, the air brake and spoiler system 322 includes one or more spoilers configured to perform the function of an air brake.

Still referring to FIG. 3, the processing circuit 310 is shown to include a memory 314. The memory 314 is one or more devices (e.g., RAM, ROM, flash memory, hard disk storage) for storing data and computer code for completing and facilitating the various user or client processes, layers, and modules described in the present disclosure. The memory 314 may be or include volatile memory or non-volatile memory and may include database components, object code components, script components, or any other type of information structure for supporting the various activities and information structures of the inventive concepts disclosed herein.

The processing circuit 310 may also include one or more processors (not shown), which may be implemented as a specific purpose processor, an application specific integrated circuit (ASIC), one or more field programmable gate arrays (FPGAs), a group of processing components, or other suitable electronic processing components. The memory 314 is communicably connected to the processor and includes computer code or instruction modules for executing one or more processes described herein. The memory 314 can include various circuits, software engines, and/or modules that cause the processor to execute the systems and methods described herein. In some embodiments, the processing circuit 310 also includes a graphics processing unit (GPU) (not shown), which can be configured to retrieve electronic instructions for generating a visualization for one or more of the flight displays 20 and execute the electronic instructions in order to generate the visualization.

The memory 314 is shown to include a contamination analysis circuit 316, a brake configuration circuit 318, and a visualization circuit 320. The contamination analysis circuit 316 is generally configured to calculate a friction level value relating to the runway surface 212 and generate an indication of friction. The friction level value generally corresponds to a coefficient of friction between runway surface 212 and tires of the aircraft 30 when aircraft 30 lands on runway 202. In some embodiments, the friction level value is calculated in response to contamination information and/or environmental information received through communications interface 312. The contamination analysis circuit 316 can be configured to calculate a friction level value using data relating to any parameter, such as contamination type, contamination depth of level, tire material, tire wear, tire texture at the point of contact, runway texture, runway material, aircraft 30 weight, etc. In this regard, the contamination analysis circuit 316 and/or the communications interface 312 can be configured to receive parameter values from any number of sources. For example, the contamination analysis circuit 316 can be configured to receive a stored parameter value from memory 314 relating to aircraft 30 weight. In another example, the contamination analysis circuit 316 can be configured to receive through the communications interface 312 parameter values provided by a user interacting with the UI elements 22. In some embodiments, the contamination analysis circuit 316 is configured to estimate a parameter value.

The contamination analysis circuit 316 can be configured to calculate the friction level value using any suitable manner. In an example embodiment, the contamination analysis circuit 316 is configured to adjust a reference value relating to the friction level in response to received contamination information and/or environmental information. In this example embodiment, the reference value can correspond to contamination information indicating “dry” or otherwise optimal conditions of the runway surface 212. In this example embodiment, when the contamination information indicates “wet” conditions, the reference value can be nominally adjusted (e.g., nominally decrease the reference value to indicate a lower coefficient of friction value). When the contamination information indicates “snow” conditions, the reference value can be even further adjusted. In other embodiments, the friction level can be calculated through reference to a database mapping various parameters to coefficient of friction values. The reference value or database may be provided in memory 314 or otherwise communicably coupled to the processing circuit.

The contamination analysis circuit 316 can be configured to generate an indication of friction in response to calculating the friction level value. The indication of friction can be provided as an output to the brake configuration circuit 318 and/or the visualization circuit 320. In some embodiments, the indication of friction is represented as the adjusted reference value as described above. In some embodiments, the indication of friction can be represented as a scaled value, for example by comparing a contamination type and/or level to a set of thresholds. For example, the indication of friction can be represented as a scaled value of “1” in dry or normal conditions of the runway 202. Each subsequent indication of friction value can each correspond to an increasingly lower friction level value and/or actual coefficient of friction value. For example, an indication of friction value of “2” can correspond to a contamination type of water and a contamination level of less than one-sixteenth inch. An indication of friction value of “3” can correspond to a contamination type of water and a contamination level of between one-sixteenth inch and one-eighth inch. Subsequent values can correspond to levels of snow, ice, oil, etc. For example, a maximum indication of friction value of “10” can correspond to the lowest coefficient of friction value (e.g., a layer of ice). Embodiments can use any suitable system of generating an indication of friction.

The memory 314 is shown to include a brake configuration circuit 318. In some embodiments, the brake configuration circuit 318 is configured to control operation of the wheel brake 306, the reverse thruster 308, and/or the air brake and spoiler system 322 in response to the received indication of friction. In some embodiments, the brake configuration circuit 318 is configured to additionally receive environmental information to control operation of the wheel brake 306, the reverse thruster 308, and/or the air brake and spoiler system 322. In some embodiments, the operation of wheel brake 306 relates to a level of brake force magnitude for landing aircraft 30 on the runway 202. In some embodiments, the operation of the reverse thruster 308 relates to a level of reverse thruster magnitude for landing the aircraft 30 on the runway 202. In some embodiments, the brake configuration circuit 318 is also configured to determine a touchdown point on runway 202. In this regard, the brake configuration circuit 318 can be communicatively coupled to the wheel brake 306, the reverse thruster 308, the air brake and spoiler system 322, and/or the flight display 20. Embodiments of system 300 can be configured such that the brake configuration circuit 318 controls operation of the wheel brake 306, the reverse thruster 308, and/or the air brake and spoiler system 322 using any information that may be useful for landing the aircraft 30.

In some embodiments, the brake configuration circuit 318 is configured to control operation of at least one of the wheel brake 306, the reverse thruster 308, or the air brake and spoiler system 322 based on comparing the determined indication of friction to one or more threshold values. For example, the brake configuration circuit 318 can generate and transmit commands to activate the wheel brake 306, the reverse thruster 308, and/or the air brake and spoiler system 322 based on a comparison of an indication of friction value to one or more threshold values. For example, a threshold value can be used to determine whether to operate the wheel brake 306, the reverse thruster 308, and/or the air brake and spoiler system 322 to decrease a speed of the aircraft 30. In conditions of the runway surface 212 with relatively low friction levels (e.g., where the aircraft 30 might slip on the ground surface), the brake configuration circuit 318 can prioritize application of the reverse thruster 308 to decrease the speed of the aircraft 30, while in conditions with relatively high friction level (e.g., normal conditions), the brake configuration circuit 318 can prioritize application of the wheel brake 306 to decrease the speed of the aircraft 30; using the wheel brake 306 may be more energy efficient than using the reverse thruster 308 as it may not require fuel to generate a force that causes the aircraft to decrease in speed.

In some embodiments, the brake configuration circuit 318 is configured to apply (e.g., cause activation of, control at) the wheel brake 306 at a nominal level (e.g., a level that would be applied if information detected by the visualization circuit 320 were not considered, or independent of a threshold value determined based on sensor data from the visualization circuit 320) or a maximum level if the indication of friction value is greater than or equal to the threshold value, while not applying the reverse thruster 308 (e.g., deliver zero thrust by the reverse thruster 308, apply the reverse thruster 308 at a minimum level) and/or the air brake and spoiler system 322. For example, the brake configuration circuit 318 can apply the reverse thruster 308 at a nominal level or a maximum level if the indication of friction value is less than the threshold value, while not applying the wheel brake 306.

In some embodiments, the brake configuration circuit 318 is configured to apply at least one of the wheel brake 306, the reverse thruster 308, and/or the air brake and spoiler system 322 according to a control scheme that depends on two or more different threshold values. For example, a first threshold value can be defined as less than a second threshold value. The brake configuration circuit 318 can compare the indication of friction value to the first threshold value and to the second threshold value. If the indication of friction value is less than or equal to the first threshold value, then the reverse thruster 308 and/or the air brake and spoiler system 322 can be applied at a nominal or maximum level while the wheel brake 306 is not applied; if the indication of friction value is greater than the first threshold value and less than or equal to the second threshold value, then the wheel brake 306 can be applied at a level that increases as a function of a difference of the indication of friction value and first threshold value (e.g., as the indication of friction value increases relative to the first threshold value, the wheel brake 306 can be applied at an increasing level), while the reverse thruster 308 and/or the air brake and spoiler system 322 can be applied at a level that decreases as a function of the difference (e.g., as the indication of friction value increases relative to the first threshold value, the reverse thruster 308 can be applied at a decreasing level). If the indication of friction value is greater than the second threshold value, the wheel brake 306 can be applied at a nominal or maximum level, while the reverse thruster 308 and/or the air brake and spoiler system 322 is not applied.

In some embodiments, the brake configuration circuit 318 can be configured to store the function(s) that define how the wheel brake 306 is applied or controlled as a brake magnitude profile. The brake magnitude profile can define a linear or non-linear relationship describing how the wheel brake 306 can be controlled as a function of the difference of the indication of friction value and threshold values. The brake configuration circuit 318 can also be configured to store the reverse thruster settings that define how the reverse thruster 308 is applied or controlled as a reverse thruster magnitude profile. The reverse thruster magnitude profile can define a linear or non-linear relationship describing how the reverse thruster 308 can be controlled as a function of the difference of the indication of friction value and threshold values. The brake configuration circuit 318 can also be configured to store air brake settings and/or spoiler settings that define how the air brake and spoiler system 322 is applied or controlled as an air brake and spoiler system profile. The air brake and spoiler system profile can define a linear or non-linear relationship describing how the air brake and spoiler system 322 can be controlled as a function of the difference of the indication of friction value and threshold values.

The memory 314 is shown to include a visualization circuit 320. The visualization circuit 320 can be configured to generate a visualization based on an indication of friction, a determined touchdown point, contamination information, and/or environmental information. For example, the visualization circuit 320 can be configured to generate a visualization indicating a touchdown point along runway length 210 for landing aircraft 30. In some embodiments, the visualization circuit 320 is configured to generate a visualization that indicates operation of the wheel brake 306, the reverse thruster 308, and/or the air brake and spoiler system 322. For example, the visualization can include various settings of the wheel brake 306, the reverse thruster 308, and/or the air brake and spoiler system 322. The visualization can also include information relating to the performance of the wheel brake 306, the reverse thruster 308, and/or the air brake and spoiler system 322 in relation to the settings. In some embodiments, the visualization includes a visual representation of the runway 202 and/or the runway surface 212 as described above with reference to FIG. 2. For example, the visualization can include an indication of contamination at one or more locations of runway surface 212.

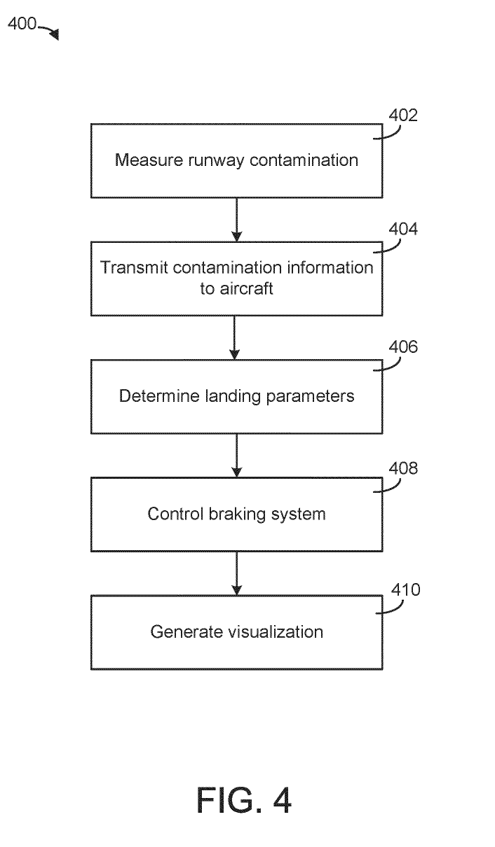

Referring now to FIG. 4, an exemplary embodiment of a method 400 of configuring an aircraft braking system based on accurate runway conditions mapping is shown according to the inventive concepts disclosed herein. In the embodiment described below, the method 400 is described as being performed by the processing circuit 310 (e.g., the contamination analysis circuit 316, the brake configuration circuit 318, and/or the visualization circuit 320). The method 400 may be performed using various hardware, apparatuses, and systems disclosed herein, including the aircraft control center 10, the system 200, the aircraft braking system 300, and/or components thereof.

At step 402, contamination on the runway surface 202 is measured. Contamination can be measured using one or more of the contamination sensors 204 configured as described with reference to system 200. Examples of measured contaminants include water, frost, slush, ice, wet ice, wet snow, wet snow over ice, dry snow, dry snow over ice, compacted snow, water over compacted snow, dry snow over compacted snow, slush over ice, ash, rubber, oil, sand, mud, etc. In some embodiments, contamination is measured by the contamination sensors 204 flush-mounted on the runway surface 212. Flush-mounting the contamination sensors 204 on the runway surface 212 may also allow a depth of contamination to be measured.

In some embodiments, step 402 also involves measuring environmental conditions. Environmental conditions can include wind speed, wind direction, temperature, humidity, or any other environmental parameter. Environmental conditions can be measured by environmental condition sensors 206 located on or around the runway 202. For example, the environmental condition sensors 206 can relate to a wind speed sensor, a wind direction sensor, a temperature sensor, a humidity sensor, or any other device capable of measuring an environmental condition relevant to landing the aircraft 30. In some embodiments, the environmental condition sensor 206 can be located on or nearby the runway surface 212. In some embodiments, one or more of the environmental condition sensors 206 can be configured at a farther distance from the runway 202 relative to the contamination sensor 204.

At step 404, contamination information is transmitted to the aircraft 30 (e.g., to the aircraft transceiver 50). Contamination information includes a contaminant type and a contaminant depth value corresponding to the contaminant type. In some embodiments, measured environmental information is also transmitted to the aircraft 30. In some embodiments, contamination information and/or environmental information is wirelessly transmitted to the aircraft 30 from the transmitter 208. In this regard, the transmitter 208 is communicably connected to the contamination sensors 204 and/or the environmental condition sensors 206, allowing the transmitter 208 to receive contamination information from the contamination sensor 204 and/or environmental information from the environmental sensor 206 via a wired or wireless interface.

The contamination information and/or environmental information can be transmitted to the aircraft transceiver 50 of the aircraft 30 using any suitable means. For example, the transmitter 208 can employ one or more antennas capable of wireless communication at one or more frequencies or channels, such as HF, VHF, SATCOM, HFDL, etc. In some embodiments, the contamination information and/or the environmental information is provided via a notice relating to NOTAM, SNOWTAM, and/or ASHTAM. In some embodiments, the transmitter 208 is configured to wirelessly transmit contamination information and/or the environmental information to the aircraft transceiver 50 in response to an indication that the aircraft 30 is within a certain distance of runway 202, such as twenty or thirty nautical miles.

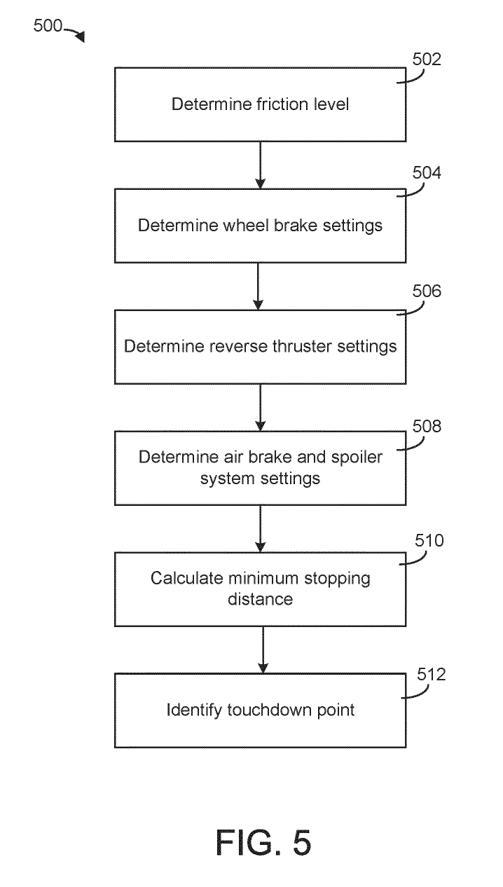

At step 406, landing parameters are determined. Landing parameters can relate a level of brake force magnitude, a level of reverse thruster magnitude, a configuration of an air brake and spoiler system, and a touchdown point on the runway 202. In some embodiments, step 406 is performed by one or more processing circuits of the aircraft 30, such as the contamination analysis circuit 316 and/or brake configuration circuit 318. In other embodiments, step 406 is performed by a processing circuit not located in the aircraft 30. A process for determining landing parameters is further described below with reference to FIG. 5.

At step 408, the braking system is controlled. In some embodiments, controlling the braking system involves controlling operation of the wheel brake 306, the reverse thruster 308, and/or the air brake and spoiler system 322. In some embodiments, the braking system is configured in response to the landing parameters determined at step 406 and/or any information that may be useful for landing the aircraft 30. In some embodiments, controlling the wheel brake 306 relates to a level of brake force magnitude for landing the aircraft 30 on the runway 202. In some embodiments, controlling the reverse thruster 308 relates to a level of reverse thruster magnitude for landing the aircraft 30 on the runway 202. In some embodiments, controlling the braking system also involves determining a touchdown point on the runway 202 for landing the aircraft 30. In some embodiments, controlling the braking system involves configuring air brake and spoiler settings for landing the aircraft 30 on the runway 202.

In some embodiments, the step 408 is performed by the brake configuration circuit 318 as described above with reference to FIG. 3. In this regard, the brake configuration circuit 318 can be communicatively coupled to the wheel brake 306, the reverse thruster 308, the air brake and spoiler system 322, and/or the flight display 20. In an example embodiment, step 408 involves the brake configuration circuit 318 controlling operation of the wheel brake 306, the reverse thruster 308, and/or the air brake and spoiler system 322 based on comparing an indication of friction value to one or more threshold values as described above with reference to FIG. 3. In some embodiments, the brake configuration circuit 318 is configured to apply at least one of the wheel brake 306, the reverse thruster 308, and/or the air brake and spoiler system 322 according to a control scheme that depends on two or more different threshold values.

At step 410, a visualization is generated. In some embodiments, step 410 is performed by the visualization circuit 320. In some embodiments, the visualization is generated in response to an indication of friction, a determined touchdown point, contamination information, and/or environmental information. For example, the visualization circuit 320 can generate a visualization indicating a touchdown point along runway length 210 for landing aircraft 30. In some embodiments, the visualization circuit 320 generates a visualization that indicates operation of the wheel brake 306, the reverse thruster 308, and/or the air brake and spoiler system 322. For example, the visualization can include various settings of the wheel brake 306, the reverse thruster 308, and/or the air brake and spoiler system 322. The visualization can also include information relating to the performance of the wheel brake 306, reverse thruster 308, and/or the air brake and spoiler system 322 in relation to the settings. In some embodiments, the visualization includes a visual representation of the runway 202 and/or the runway surface 212 as described above with reference to FIG. 2. For example, the visualization can include an indication of contamination at one or more locations of runway surface 212.

Referring now to FIG. 5, an exemplary embodiment of a method 500 describes in further detail the determining landing parameters of an aircraft braking system (step 406) according to the inventive concepts disclosed herein. In the embodiment described below, the method 500 is described as being performed by the processing circuit 310 (e.g., the contamination analysis circuit 316 and/or the brake configuration circuit 318). In other embodiments, the method 500 may be performed using various hardware, apparatuses, and systems disclosed herein.

At step 502, the processing circuit 310 determines a friction level relating to the runway surface 212. The friction level value generally corresponds to a coefficient of friction between the runway surface 212 and tires of the aircraft 30 when landing on the runway 202. The friction level value can be determined or calculated using any suitable algorithm or method. For example, the friction level value can be calculated using data relating to any parameter, such as contamination type, contamination depth of level, tire material, tire wear, tire texture at the point of contact, runway texture, runway material, aircraft weight, etc. In some embodiments, the friction level value is calculated based on contamination information and/or environmental information.

In some embodiments, step 502 is performed by the contamination analysis circuit 316 as described above with reference to FIG. 3. For example, the contamination analysis circuit 316 can adjust a reference value relating to the friction level in response to received contamination information and/or environmental information. In this example embodiment, the reference value can correspond to contamination information indicating “dry” or otherwise optimal conditions of the runway surface 212. When the contamination information indicates “wet” conditions, the reference value can be nominally adjusted (e.g., nominally decrease the reference value to indicate a lower coefficient of friction value). When the contamination information indicates “snow” conditions, the reference value can be even further adjusted. In other embodiments, the friction level can be calculated through reference to a database mapping parameters to various coefficient of friction values. The reference value or database may be provided in the memory 314 or otherwise communicably coupled to the contamination analysis circuit 316.

In some embodiments, the processing circuit 310 determines an indication of friction in response to calculating the friction level value. The indication of friction can be used for determining wheel brake settings (step 504), determining reverse thruster settings (step 506), determining air brake and spoiler system settings (508), and/or identifying a touchdown point (step 512). In some embodiments, the indication of friction is represented as the adjusted reference value as described above. In some embodiments, the indication of friction can be represented as a scaled value, for example by comparing a contamination type and/or level to a set of thresholds. For example, the indication of friction can be represented as a scaled value of “1” in dry or normal conditions of the runway 202. Each subsequent indication of friction value can each correspond to an increasingly lower friction level value and/or actual coefficient of friction value. For example, an indication of friction value of “2” can correspond to a contamination type of water and a contamination level of less than one-sixteenth inch. An indication of friction value of “3” can correspond to a contamination type of water and a contamination level of between one-sixteenth inch and one-eighth inch. Subsequent values can correspond to levels of snow, ice, oil, etc. For example, a maximum indication of friction value of “10” can correspond to the lowest coefficient of friction value (e.g., a layer of ice).

At step 504, wheel brake settings are determined. In some embodiments, the wheel brake settings are determined in conjunction with determining the reverse thruster settings (step 506) and/or determining the air brake and spoiler system settings (step 508). The wheel brake settings generally relate to a level of brake force magnitude of the wheel brake 306 for landing the aircraft 30 on the runway 202 as described above with reference to FIG. 3. The reverse thruster settings relate to a level of reverse thruster magnitude for landing the aircraft 30 on runway 202 as described above with reference to FIG. 3. The air brake and spoiler system settings relate to a configuration of an air brake and/or a spoiler for landing the aircraft 30 on the runway 202 as described above with reference to FIG. 3. In some embodiments, the wheel brake settings, the reverse thruster settings, and/or the air brake and spoiler system settings are determined in response to the calculated friction level at step 502.

In some embodiments, the processing circuit may prioritize application of the wheel brake 306 or application of the reverse thruster 308 based on the indication of friction value. For example, when the friction level is relatively low (e.g., when higher contamination on the runway may cause slip), the processing circuit 310 can prioritize application of the reverse thruster 308 to decrease the speed of the aircraft 30. In contrast, when determined friction level is relatively high (e.g., dry conditions), the processing circuit 310 can prioritize application of the wheel brake 306. This may be desirable because using the wheel brake 306 may be more energy efficient than using the reverse thruster 308 as it may not require fuel to generate a force that causes the aircraft 30 to decrease in speed.

In some embodiments, the wheel brake settings (step 504), the reverse thruster settings (step 506), and/or the air brake and spoiler system settings (step 508) are determined based on environmental information. For example, environmental information may include a wind direction value and a wind direction speed. The processing circuit 310 may decrease a reverse thruster magnitude setting or a brake force setting in response to the environmental information indicating a heavy headwind. In another example, the environmental information may indicate a temperature value below freezing when contamination information indicates water on the runway 202. The processing circuit 310 may increase a reverse thruster magnitude setting to account for possible ice formation on runway 202.

In some embodiments, the processing circuit 310 determines wheel brake settings (step 504), determines reverse thruster settings (step 506), and/or determines the air brake and spoiler system settings (step 508) based on comparing the determined indication of friction value to one or more threshold values. For example, a threshold value can be used to determine whether to operate the wheel brake 306, the reverse thruster 308, and/or the air brake and spoiler system 322 to decrease a speed of the aircraft 30. In some embodiments, wheel brake settings involve activation of the wheel brake 306 at a nominal level or a maximum level if the indication of friction value is greater than or equal to the threshold value, while the reverse thruster settings involve not applying the reverse thruster 308 (e.g., deliver zero thrust by the reverse thruster 308, apply the reverse thruster 308 at a minimum level).

In some embodiments, the wheel brake settings (step 504), the reverse thruster settings (step 506), and/or the air brake and spoiler system settings (step 508) are determined according to a control scheme that depends on two or more different threshold values. For example, a first threshold value can be defined as less than a second threshold value. The processing circuit 310 can compare the indication of friction value to the first threshold value and to the second threshold value. If the indication of friction value is less than or equal to the first threshold value, then the control scheme can involve applying reverse thruster 308 and/or the air brake and spoiler system 322 at a nominal or maximum level while the wheel brake 306 is not applied; if the indication of friction is greater than the first threshold value and less than or equal to the second threshold value, then the wheel brake 306 can be applied at a level that increases as a function of a difference of the indication of friction value and first threshold value (e.g., as the indication of friction value increases relative to the first threshold value, the wheel brake 306 can be applied at an increasing level), while the reverse thruster 308 and/or the air brake and spoiler system 322 can be applied at a level that decreases as a function of the difference (e.g., as the indication of friction value increases relative to the first threshold value, the reverse thruster 308 can be applied at a decreasing level). If the indication of friction is greater than the second threshold value, the wheel brake 306 can be applied at a nominal or maximum level, while the reverse thruster 308 and/or the air brake and spoiler system 322 is not applied.

In some embodiments, step 504 involves storing the wheel brake settings relating to the function(s) that define how the wheel brake 306 is applied or controlled as a brake magnitude profile. The brake magnitude profile can define a linear or non-linear relationship describing how the wheel brake 306 can be controlled as a function of the difference of the indication of friction value and threshold values. In some embodiments, step 506 involves storing the reverse thruster settings that define how the reverse thruster 308 is applied or controlled as a reverse thruster magnitude profile. The reverse thruster magnitude profile can define a linear or non-linear relationship describing how the reverse thruster 308 can be controlled as a function of the difference of the indication of friction value and threshold values. In some embodiments, step 508 involves storing the air brake and spoiler settings that define how the air brake and spoiler system 322 is applied or controlled as an air brake and spoiler system profile. The air brake and spoiler system profile can define a linear or non-linear relationship describing how the air brake and spoiler system 322 can be controlled as a function of the difference of the indication of friction value and threshold values.

At step 510, the processing circuit 310 calculates a minimum stopping distance for landing the aircraft 30 on the runway 202. The minimum stopping distance can correspond to a distance required to stop movement of the aircraft 30 when landing using the wheel brake 306, the reverse thruster 308, and/or the air brake and spoiler system 322. In this regard, in some embodiments the minimum stopping distance may be calculated using determined friction level (step 502), determined brake setting (step 504), determined reverse thruster settings (step 506), and/or determined air brake and spoiler system settings (step 508). In some embodiments, the minimum stopping distance is a value corresponding to an expected landing distance plus an additional distance value to account for possible measurement tolerances of the contamination sensors 204 and/or the environmental condition sensors 206, a margin of error, and/or a safety margin.

In some embodiments, step 510 is conducted in conjunction with steps 504, 506, and/or 508. For example, the processing circuit 310 may determine wheel brake settings (step 504), reverse thruster settings (step 506), and/or air brake and spoiler system settings (step 508) such that aircraft 30 can land within the minimum stopping distance. Accordingly, each of the wheel brake settings, the reverse thruster settings, the air brake and spoiler system settings, and the minimum stopping distance can be collectively determined.

In some embodiments, the minimum stopping distance can be calculated by adjusting an expected stopping distance value corresponding to dry or normal conditions of the runway 202. Thus, when contamination information indicates a dry runway condition, the processing circuit 310 can be configured to not adjust the minimum stopping distance. When contamination information indicates lower friction levels, the processing circuit 310 can be configured to increase the minimum stopping distance. In some embodiments, the processing circuit 310 may increase the minimum stopping distance in response to the environmental information. For example, a heavy tailwind may cause the processing circuit 310 to increase a minimum stopping distance.

At step 512, the processing circuit 310 identifies a touchdown point for landing the aircraft 30 on the runway 202. The touchdown point generally corresponds to a point along the runway length 210 in which the aircraft 30 makes first contact when landing on the runway 202. In some embodiments, the processing circuit 310 identifies the touchdown point by determining that the minimum stopping distance (step 510) measured from the touchdown point allows the aircraft 30 to make a complete stop without travelling beyond the endpoint of the runway 202. In some embodiments, the processing circuit 310 identifies a touchdown point using contamination information and/or environmental information. For example, the processing circuit 310 can identify a touchdown point on the runway 202 that minimizes exposure of contaminants on the runway surface 212 when landing. The processing circuit 310 can use any information for identifying a touchdown point, such as slat/flap configuration, wheel brake settings, reverse thruster settings, air brake or spoiler settings, aircraft weight, descent speed, descent angle, etc.

In some embodiments, the inventive concepts disclosed herein may be applied to takeoff conditions, such as for determining a safe rejected-takeoff stopping distance. For example, runway surface conditions can be determined and displayed while the aircraft is taxiing or accelerating for takeoff.

In some embodiments, the inventive concepts disclosed herein may be applied to a ground-based vehicle (e.g., an automobile). For example, road or ground surface conditions can be determined, and used by a braking system (e.g., and anti-lock braking system) to tune a braking output based on detected surface conditions.

As will be appreciated from the above, systems and methods for controlling operation of an aircraft based on surface conditions according to embodiments of the inventive concepts disclosed herein may improve operation of aircrafts by showing an operator of the aircraft where regions on a surface may have low friction level, and/or controlling operation of a brake or a reverse thruster based on the surface conditions.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried out in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system for use with a sensor configured to measure contamination on a runway surface and to output contamination information relating to the measured contamination, and a transmitter configured to receive the contamination information and to wirelessly communicate the received contamination information, the system comprising:
a processing circuit and a transceiver, the transceiver configured for wireless communication with the transmitter; wherein the processing circuit is configured to:
receive the contamination information;
determine a plurality of landing parameters based on the contamination information; and
control at least one of a wheel brake or a reverse thruster of an aircraft in response to determining the plurality of landing parameters.

2. The system of claim 1, wherein the contamination information comprises a contaminant type and a contaminant depth value corresponding to the contaminant type.

3. The system of claim 1, wherein the processing circuit is further configured to control at least one of an air brake or a spoiler of the aircraft in response to determining the plurality of landing parameters.

4. The system of claim 1, further comprising a second sensor configured to measure environmental conditions associated with the runway surface and to output environmental information relating to the measured environmental conditions, wherein:
the transmitter is further configured to receive the environmental information and to wirelessly communicate the received environmental information; and
the processing circuit is further configured to:
receive the environmental information; and
determine the plurality of landing parameters based on the contamination information and the environmental information.

5. The system of claim 1, wherein the transmitter is configured to wirelessly communicate the received contamination information to the aircraft when the aircraft is less than twenty nautical miles from the runway surface.

6. The system of claim 1, wherein the aircraft further comprises a display device and the processing circuit is further configured to generate a visualization based on the plurality of landing parameters.

7. The system of claim 1, wherein the plurality of landing parameters comprises a minimum stopping distance.

8. A method comprising:
measuring, by a sensor, contamination on a runway surface;
communicating, by a transmitter, contamination information to an aircraft, the contamination information relating to the measured contamination;
determining, by a processing circuit of the aircraft, a plurality of landing parameters based on the contamination information; and
controlling, by the processing circuit, at least one of a wheel brake or a reverse thruster in response to determining the plurality of landing parameters.

9. The method of claim 8, wherein the contamination information comprises a contaminant type and a contaminant depth value corresponding to the contaminant type.

10. The method of claim 9, wherein the contaminant type is one of: water, frost, slush, ice, wet ice, wet snow, wet snow over ice, dry snow, dry snow over ice, compacted snow, water over compacted snow, dry snow over compacted snow, slush over ice, ash, rubber, oil, sand, or mud.

11. The method of claim 8, further comprising:
measuring, by a second sensor, environmental conditions associated with the runway surface;
communicating, by the transmitter, environmental information relating to the measured environmental conditions; and
determining, by the processing circuit, the plurality of landing parameters based on the contamination information and the environmental information.

12. The method of claim 8, wherein the transmitter wirelessly communicates the received contamination information to the aircraft when the aircraft is less than twenty nautical miles from the runway surface.

13. The method of claim 8, further comprising:
generating, by the processing circuit, a visualization for display by a display device based on the plurality of landing parameters.

14. The method of claim 8, wherein the plurality of landing parameters comprises a minimum stopping distance.

15. A brake control unit having a processing circuit configured to be communicably coupled to a transceiver of an aircraft, the processing circuit configured to:
receive contamination information relating to measured contamination of a runway surface;
determine a plurality of landing parameters based on the contamination information; and
control at least one of a wheel brake or a reverse thruster in response to determining the plurality of landing parameters.

16. The brake control unit of claim 15, wherein the contamination information comprises a contaminant type and a contaminant depth value corresponding to the contaminant type.

17. The brake control unit of claim 16, wherein the contaminant type is one of: water, frost, slush, ice, wet ice, wet snow, wet snow over ice, dry snow, dry snow over ice, compacted snow, water over compacted snow, dry snow over compacted snow, slush over ice, ash, rubber, oil, sand, or mud.

18. The brake control unit of claim 15, wherein the processing circuit is further configured to:
receive environmental information relating to measured environmental conditions associated with the runway surface;
determine the plurality of landing parameters based on the contamination information and the environmental information.

19. The brake control unit of claim 15, wherein the processing circuit is configured to determine the plurality of landing parameters in response to determining the aircraft is less than twenty nautical miles from the runway surface.

20. The brake control unit of claim 15, wherein the processing circuit is further configured to generate a visualization for display by a display device based on the plurality of landing parameters.
